(19) United States
(12) Patent Application Publication
(10) Pub. No.: US 2023/0135024 A1
(43) Pub. Date: May 4, 2023

(54) Imaging Device and Imaging Method

(71) Applicant: Faurecia Clarion Electronics Co., Ltd., Saitama (JP)

(72) Inventor: Junichi SAKAI, Saitama (JP)

(73) Assignee: Faurecia Clarion Electronics Co., Ltd., Saitama (JP)

(21) Appl. No.: 17/972,118

(22) Filed: Oct. 24, 2022

(30) Foreign Application Priority Data
Oct. 29, 2021 (JP) 2021-177109

(51) Int. Cl. H04N 5/33; H04N 9/04

(52) U.S. Cl. CPC H04N 5/332; H04N 9/04553

(57) ABSTRACT

A control unit of an imaging device includes a switching unit that switches between a first process that generates the visible light image from the output signals of the R pixels, the G pixels and the B pixels, and generates a first infrared light image from the output signals of the IR pixels, and a second process that causes the imaging unit to execute imaging in a first state. The infrared light emitting unit emits infrared light and a second state wherein the infrared light emitting unit does not emit infrared light, to generate the second infrared light image from the output signals of the IR pixels in the first state and from the difference values ΔR, ΔG and ΔB between the respective output signals of the R pixels, G pixels, and B pixels in the first state and the respective R pixels, G pixels and B pixels in the second state.

### CROSS-REFERENCE TO RELATED APPLICATIONS

The present application claims priority under 35 U.S.C.§ 119 to Japanese Patent Application No. 2021-177109 filed on Oct. 29, 2021. The content of the application is incorporated herein by reference in its entirety.

### BACKGROUND OF THE INVENTION

### Field of the Invention

The present invention relates to an imaging device and an imaging method.

### Description of the Related Art

Conventionally there is a known technology for displaying an infrared light image on a display device.

For example, Patent Document 1 describes an information providing system as follows. An invisible marker is made of a transparent substance that has retroreflective characteristics. A camera has an infrared light LED that emits infrared light, a CMOS that is able to capture light in frequency domains for both the infrared light domain and the visible light domain, and an FPGA for controlling so as to execute a process for capturing an image by the CMOS under visible light and infrared light (hereinafter referred as “visible-infrared image”) under the condition of illuminating the object with infrared light by the infrared light LED under visible light, and a process for capturing an image under visible light without illumination by the infrared light (hereinafter referred as “visible image”). A wearable computer generates a difference image that is the difference between the visible-infrared image and the visible image, and detect an invisible marker that is included in the difference image.

### Prior Art Document

### Patent Document

[Patent Document 1] Japanese Unexamined Patent Application Publication 2010-50757

In conventional devices such as the information providing system described in Patent Document 1, it has not been possible to switch between the visible light image and the infrared light image.

For example, in some cases, the imaging device is required to generate a visible light image during the day and an infrared light image at night.

Moreover, in an RGB-IR camera, R pixels, G pixels, B pixels, and IR pixels are arranged in a 1:4:1:2 proportion. Therefore, the size of the infrared light image is ¼ of whole pixels of the RGB-IR camera. It is required to use a high-resolution RGB-IR camera for producing a high-resolution infrared light image.

### SUMMARY OF THE INVENTION

The object of the present invention is to provide an imaging device and imaging method that is possible to switch the generated image between the combination of a visible light image and a low-resolution infrared light image, and a high-resolution infrared light image alone.

In order to solve the problems set forth above, the imaging device according to the present invention comprises, for example: an imaging unit wherein R pixels, G pixels, B pixels and IR pixels are arranged periodically; an infrared light emitting unit that emits infrared light to the surroundings; a signal processing unit that generates an image from an output signal of the imaging unit; and a control unit that controls the imaging unit, the infrared light emitting unit and the signal processing unit, wherein each of the R pixels, the G pixels, the B pixels and the IR pixels has a filter that is transparent to IR light, and the control unit switches its control between a first process wherein the signal processing unit simultaneously generate a visible light image from the output signals of the R pixels, the G pixels and the B pixel of the imaging unit, and a first infrared light image from the output signals of the IR pixels of the imaging unit, and a second process wherein the imaging unit outputs the output signals during a first state during which the infrared light emitting unit is emitting infrared light and in a second state during which the infrared light emitting unit is not emitting infrared light, and the signal processing unit generates a second infrared light image from difference values between the output signals of the R pixels, the G pixels and the B pixels during the first state and the output signals of the R pixels, the G pixels and the B pixels during the second state, and the output signals of the IR pixels in the first state.

### Effects of the Invention

According to the imaging device and imaging method of the present invention, it is possible to switch the generated image between the combination of the visible light image and the low-resolution infrared light image, and the high-resolution infrared light image.

### BRIEF DESCRIPTION OF THE DRAWINGS

FIG. 1 shows a structural diagram of an imaging device according to the present invention.

FIG. 2 shows a first process for outputting the visible light image.

FIG. 3 is a graph showing a first gain adjusting process in the first process.

FIG. 4 shows a second process for outputting the infrared light image.

FIG. 5 is a graph showing a second gain adjusting process in the second process.

FIG. 6 is a flowchart processed by the control unit.

### DETAILED DESCRIPTION OF THE INVENTION

Embodiments of the present invention will be described below with reference to the drawings.

[1. Structure of the Imaging Device]

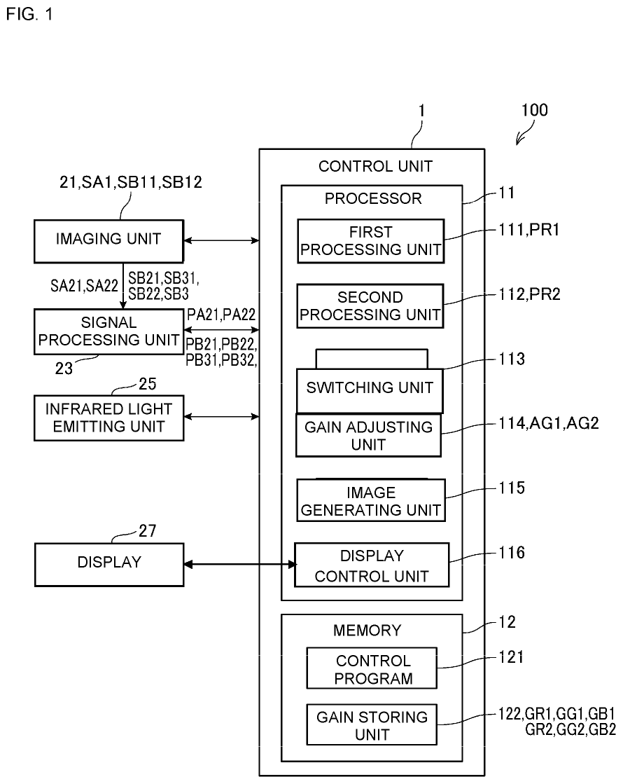

FIG. 1 will be referenced to explain the structure of an imaging device 100. FIG. 1 is an example of a structure diagram of an imaging device 100 according to the present invention.

As shown in FIG. 1, the imaging device 100 according to the present invention comprises a control unit 1, an imaging unit 21, a signal processing unit 23, an infrared light emitting unit 25, and a display 27.

For example, the imaging device 100 is installed in a vehicle to image within the vehicle.

On the imaging unit 21, R pixels, G pixels, B pixels, and IR pixels are arrangement periodically. Specifically, the R pixels, G pixels, B pixels, and IR pixels may be arranged in a so-called “RGB-IR layout” for example.

Each R pixel, G pixel, B pixel, and IR pixel has a filter and an image sensor such as a CCD (Charge-Coupled Device), CMOS (Complementary Metal Oxide Semiconductor). The filter limits the wavelengths of incident light from the outside into the image sensor.

The filter of the R pixel transmits R (Red) light and IR (infrared) light and cuts G (Green) light and B (Blue) light. The filter of the G pixel transmits G light and IR light, and cuts R light and B light. The filter of the B pixel transmits B light and IR light, and cuts R and G light. The filter of the IR pixel transmits IR light and cuts R light, G light, and B light.

In the present embodiment, the explanation will be for the case wherein the wavelength of the B light is 460 nm, the wavelength of the G light is 540 nm, the wavelength of the R light is 600 nm, and the wavelength of the IR light is 920 nm for example.

According to an instruction from the control unit 1, the imaging unit 21 generates an output signal SA1 that corresponds to an image PA1 of an “RGB-IR layout” for example, and outputs output signals SA21 and SA22 to a signal processing unit 23. The output signal SA21 corresponds to the visible light image PA21 of an “RGGB layout.” The output signal SA22 corresponds to a first infrared light image PA22.

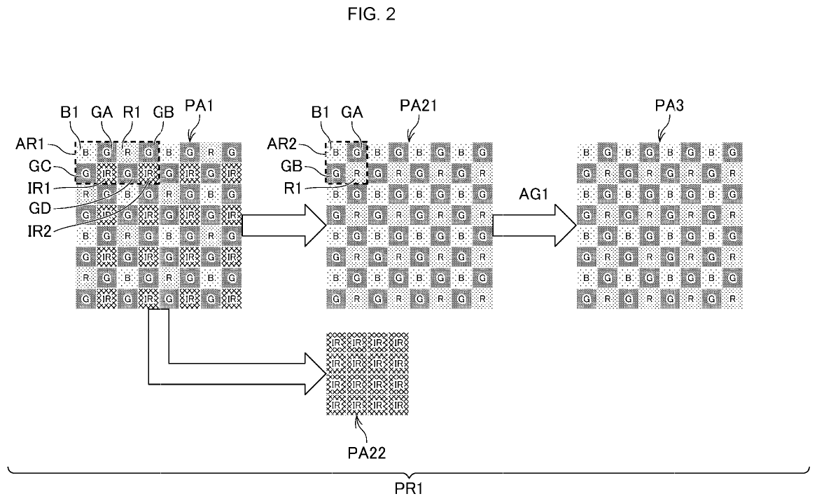

The “RGB-IR layout” and the “RGGB layout” will be explained later in reference to FIG. 2. The visible light image PA21 and the first infrared light image PA22 will be also explained later in reference to FIG. 2.

According to an instruction from the control unit 1, the signal processing unit 23 generates images from the output signals SA21 and SA22 of the imaging unit 21. Specifically, the signal processing unit 23 generates the visible light image PA21 from the output signal SA21 and the first infrared light image PA22 from the output signal SA22.

The signal processing unit 23 outputs the visible light image PA21 and the first infrared light image PA22 to the control unit 1.

The infrared light emitting unit 25 emits infrared light into the surroundings according to an instruction from the control unit 1. The infrared light emitting unit 25 may provide an LED (Light-Emitting Diode) that emits infrared light as a light source.

A display 27 is made of an LCD (Liquid Crystal Display) to display various images by following instructions from the control unit 1.

In the present embodiment, the control unit 1 is configured as an ECU (Electronic Control Unit) of an automobile. The control unit 1 controls the image displayed on the display 27. The control unit 1 comprises a processor 11 and a memory 12.

The memory 12 is a non-volatile storing device for storing of a control program 121 to be executed by a processor 11 and other related data. The memory 12 may be a magnetic storing device, a semiconductor storing element such as a flash ROM (Read-Only Memory), or some other type of non-volatile storing device. The memory 12 may also include a RAM (Random Access Memory) for providing a work area for the processor 11. The memory 12 stores data to be processed by the control unit 1 and a control program 121 to be executed by the processor 11.

The processor 11 may be a single processor or a multi-processor system.

The control unit 1 may be an integrated circuit. Integrated circuits include LSIs (Large Scale Integrations), ASICs (Application Specific Integrated Circuits), and PLDs (Programmable Logic Devices). PLDs include FPGAs (Field-Programmable Gate Arrays) for example.

The integrated circuit may include analog circuits, otherwise be a combination of a processor and an integrated circuit. The combination of a processor and an integrated circuit is called a microcontroller (MCU), an SoC (system-on-a-chip), a system LSI or a chipset.

The control unit 1 is connected communicatively to an imaging unit 21, a signal processing unit 23, an infrared light emitting unit 25 and a display 27. The control unit 1 may follow a standard such as Ethernet (registered trademark) to communicate with the imaging unit 21, the signal processing unit 23, the infrared light emitting unit 25 and the display 27.

[2. Structure of the Control Unit]

The structure of the control unit 1 will be explained by referring FIG. 1.

As illustrated in FIG. 1, the control unit 1 comprises a first processing unit 111, a second processing unit 112, a switching unit 113, a gain adjusting unit 114, an image generating unit 115, a display control unit 116 and a gain storing unit 122.

The first processing unit 111, the second processing unit 112, the switching unit 113, the gain adjusting unit 114, the image generating unit 115, and the display control unit 116 are implemented by the processor 11 through executing the control program 121 stored in the memory 12. The memory 12 functions as the gain storing unit 122 by executing the control program 121 stored in the memory 12 by the processor 11.

The gain storing unit 122 stores a gain adjustment result by the gain adjusting unit 114.

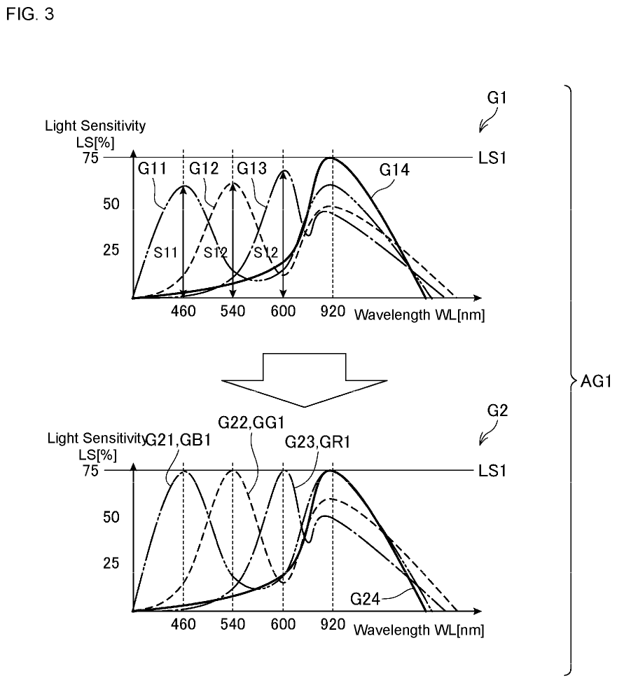

For example, for generating a first visible light image PA3 and a first infrared light image PA22 by the first processing unit 111, the gain adjusting unit 114 stores a gain GR1, a gain GG1 and a gain GB1 in the gain storing unit 122 as explained later in reference to FIG. 3.

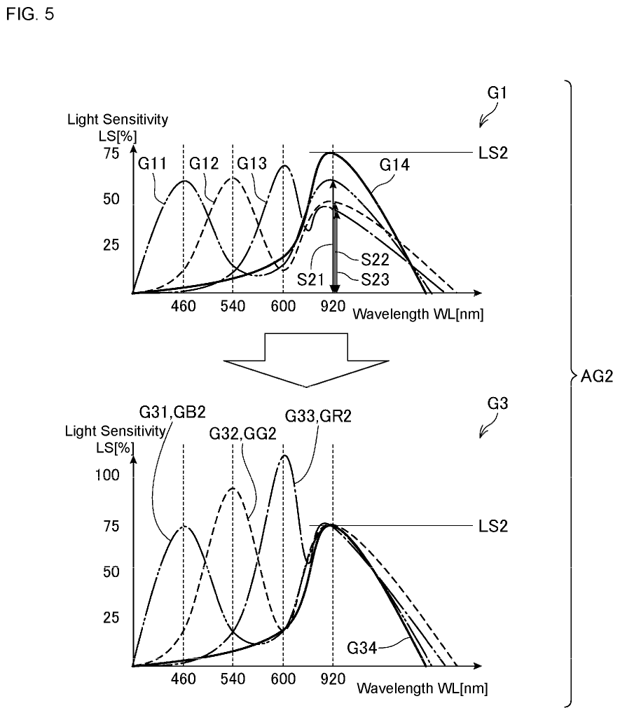

Also, for generating a second infrared light image PB6 by the first processing unit 111, the gain adjusting unit 114 stores a gain GR2, a gain GG2, and a gain GB2 in the gain storing unit 122 as explained later in reference to FIG. 5.

The first processing unit 111 executes a first process PR1 to generate the first visible light image PA3 from the output signals SA21 of the R pixels, the G pixels, and the B pixels, and to generate the first infrared light image PA22 from the output signals SA22 from the IR pixels.

In the present embodiment, the first processing unit 111 causes the infrared light emitting unit 25 to emit infrared light in the first process PR1.

The first process PR1, the first visible light image PA3 and the first infrared light image PA22 will be further explained later in reference to FIG. 2.

In the first embodiment, the first processing unit 111 was explained for the case of causing the infrared light emitting unit 25 to emit infrared light in the first process PR1 but there is no limitation thereto. The first processing unit 111 is not necessarily to cause the infrared light emitting unit 25 to emit radiation in the first process PR1. In such a case, the brightness of the first infrared light image PA22 will be reduced compared to the case that the infrared light emitting unit 25 emits infrared light.

The second processing unit 112 executes a second process PR2 as explained below. That is, the second processing unit 112 causes the imaging unit 21 to capture an image in a first state ST1 wherein the infrared light emitting unit 25 is emitting infrared light, and to capture another image in a second state ST2 wherein the infrared light emitting unit 25 is not emitting infrared light. The second processing unit 112 generate a second infrared light image PB6 from the difference values between an output signals SB21 for the R pixels, G pixels, and B pixels in the first state ST1 and an output signals SB22 for the R pixels, G pixels, and B pixels in the second state ST2, and an output signal SB31 of the IR pixels in the first state ST1.

Note that the difference values comprise difference values ΔR, difference values ΔG, and difference values ΔB. The difference values are calculated by the image generating unit 115.

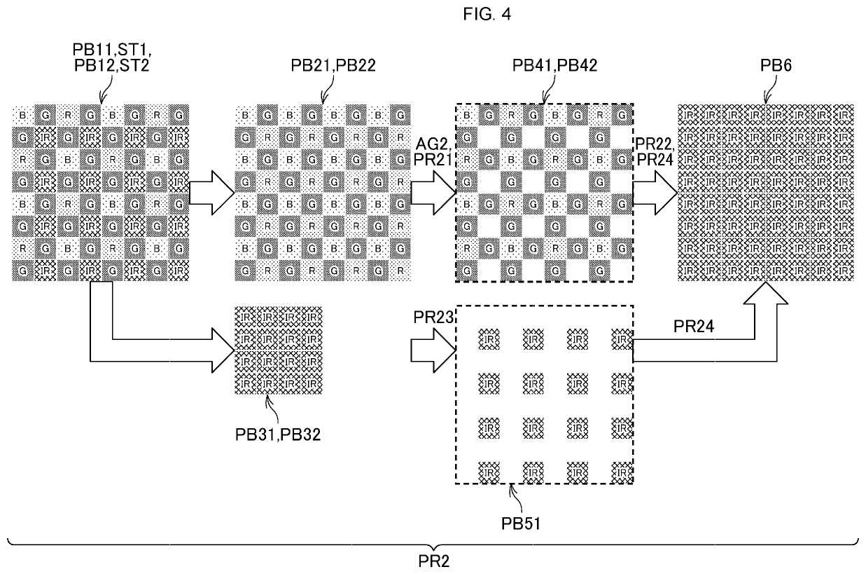

The second process PR2 and the second infrared light image PB6 will be explained further in reference to FIG. 4.

The switching unit 113, in response to an instruction from a user, switches between the first process PR1 and the second process PR2. If the user has selected the first process PR1, the switching unit 113 causes the first processing unit 111 to execute the first process PR1. If the user has selected the second process PR2, the switching unit 113 causes the second processing unit 112 to execute the second process PR2.

In the first process PR1, the gain adjusting unit 114 adjusts the gains GR1, GG1, and GB1, and stores the gain GR1, the gain GG1, and the gain GB1 in the gain storing unit 122 as explained below. In other words, the gain adjusting unit 114 adjusts the gain GR1, the gain GG1 and the gain GB1 by following an instruction from the first processing unit 111. The gain GR1 is the gain to be multiplied to the output signals from the R pixels in the first process PR1. The gain GG1 is the gain to be multiplied to the output signals from the G pixels in the first process PR1. The gain GB1 is the gain to be multiplied to the output signals from the B pixels in the first process PR1. Note that the process for adjusting the gain GR1, the gain GG1 and the gain GB1 in the first process PR1 will be described as the “first gain adjusting process AG1” in the explanation below.

The gain adjusting unit 114 adjusts the gain GR1 for the output signals of the R pixels so that the sensitivity of the R light components that are included in the outputs of the R pixels will match the sensitivity of the IR light components that are included in the output signals of the IR pixels.

The gain adjusting unit 114 also adjusts the gain GG1 for the output signals of the G pixels so that the sensitivity of the G light components that are included in the outputs of the G pixels will match the sensitivity of the IR light components that are included in the output signals of the IR pixels.

The gain adjusting unit 114 also adjusts the gain GB1 for the output signals of the B pixels so that the sensitivity of the B light components that are included in the outputs of the B pixels will match the sensitivity of the IR light components that are included in the output signals of the IR pixels.

Details of the first gain adjusting process AG1 will be explained later in reference to FIG. 3.

In the second process PR2, the gain adjusting unit 114 adjusts the gains GR2, GG2, and GB2 as explained below, and stores them in the gain storing unit 122. In other words, the gain adjusting unit 114 adjusts the gain GR2, the gain GG2 and the gain GB2 by following instructions from the second processing unit 112. The gain GR2 is the gain for multiplying to the output signals from the R pixels in the second process PR2. The gain GG2 is the gain for multiplying to the output signals from the G pixels in the second process PR2. The gain GB2 is the gain for multiplying to the output signals from the B pixels in the second process PR2.

Note that the process for adjusting the gain GR2, the gain GG2 and the gain GB in the second process PR2 may be referred as the “second gain adjusting process AG2” in the explanation below.

The gain adjusting unit 114 adjusts the gain GR2 for the output signals of the R pixels so that the sensitivity of the IR light components included in the outputs of the R pixels in the first state ST1 matches the sensitivity of the IR light components included in the output signals of the IR pixels in the first state ST1.

The gain adjusting unit 114 also adjusts the gain GG2 for the output signals of the G pixels so that the sensitivity of the IR light components included in the outputs of the G pixels in the first state ST1 matches the sensitivity of the IR light components included in the output signals of the IR pixels in the first state ST1.

The gain adjusting unit 114 adjusts the gain GB2 for the output signals of the B pixels so that the sensitivity of the IR light components included in the outputs of the B pixels in the first state ST1 matches the sensitivity of the IR light components included in the output signals of the IR pixels in the first state ST1.

Details of the second gain adjusting process AG2 is explained later in reference to FIG. 5.

The image generating unit 115 generates the second infrared light image PB6 in the second process PR2 as explained below. In other words, the image generating unit 115 generates the second infrared light image PB6 by following an instruction from the second processing unit 112.

That is, the image generating unit 115 calculates difference values ΔR between the output signals of the R pixels in a first state ST1 and the output signals of the R pixels in a second state ST2. The image generating unit 115 also calculates difference values ΔG between the output signals of the G pixels in the first state ST1 and the output signals of the G pixels in the second state ST2. The image generating unit 115 also calculates difference values ΔB between the output signals of the B pixels in the first state ST1 and the output signals of the B pixels in the second state ST2.

Then, the image generating unit 115 generates a second infrared light image PB6 by arranging, the difference values ΔR, the difference values ΔG, the difference values ΔB, and the output signals of the IR pixels in the first state ST1 in the RGB-IR arrangement.

Details of the processing in the image generating unit 115 will be explained later in reference to FIG. 5.

The display control unit 116 displays the first visible light image PA3 and first infrared light image PA22 generated by the first processing unit 111, and the second infrared light image PB6 generated by the second processing unit 112.

[3. First Process]

Next, the first process PR1 will be explained in reference to FIG. 2 and FIG. 3.

FIG. 2 is a diagram explaining an example of the first process PR1 for outputting the first visible light image PA3.

The image PA1 is an image in the “RGB-IR layout,” generated by the imaging unit 21.

In the image PA1 that is an example of the “RGB-IR layout,” the eight pixels in the region AR1 indicated by the dotted line form a single unit. The image PA1 is composed by arranging these eight pixels in the vertical and horizontal directions. Eight pixels, i.e., an R pixel R1, a G pixel GA, a G pixel GB, a G pixel GC, a G pixel GD, a B pixel B1, an IR pixel IR1 and an IR pixel IR2, are arranged in the region AR1.

On the top row in the region AR1, four pixels are arranged in sequence: a B pixel B1, a G pixel GA, an R pixel R1 and a G pixel GB from left to right. On the bottom row in the region AR1, four pixels arranged in sequence: a G pixel GC, an IR pixel IR1, a G pixel GD and an IR pixel IR2 from left to right.

The imaging unit 21 outputs the output signal SA21 and the output signal SA22 to the signal processing unit 23. The output signal SA21 corresponds to a visible light image PA21. The output signal SA22 corresponds to the first infrared light image PA22.

The signal processing unit 23 generates the visible light image PA21 from the output signals SA21, and also generates the first infrared light image PA22 from the output signal SA22.

The visible light image PA21 is an image in the “RGGB layout.”

In the visible light image PA21 that is an example of an RGGB, the four pixels within the region AR2, indicated by the dotted line, form a single unit. The visible light image PA21 is composed by arranging four pixels vertically and horizontally. Four pixels, i.e., a B pixel B1, a G pixel GA, a G pixel GB, and an R pixel R1, are arranged in the region AR2.

On the top row in the region AR2, two pixels, i.e., the B pixel B1 and the G pixel GA, are arranged in that order from left to right. In the bottom row of the region AR2, two pixels, i.e., the G pixel GB and the R pixel R1, are arranged in the order from left to right.

The first infrared light image PA22 is generated from the output signal SA22 of the IR pixels, such as the IR pixel IR1 and the IR pixel IR2, included in the image PA1. For example, the first infrared light image PA22 is composed by the output signals of 16 pixels because 16 IR pixels are included in the image PA1 shown in FIG. 2.

The first processing unit 111 instructs the gain adjusting unit 114 to adjust the gain GR1, the gain GG1, and the gain GB1 by executing the first gain adjusting process AG1.

The gain adjusting unit 114 multiplies, by the gain GR1, the output signals from each of the R pixels included in the visible light image PA21. The gain adjusting unit 114 also multiplies, by the gain GG1, the output signals from each of the G pixels included in the visible light image PA21. The gain adjusting unit 114 also multiplies, by the gain GB1, the output signals from each of the B pixels included in the visible light image PA21. As a result, the gain adjusting unit 114 generates the first visible light image PA3.

Next, the first gain adjusting process AG1 executed by the gain adjusting unit 114 will be explained by referring FIG. 3. The graph of FIG. 3 shows an example of the first gain adjusting process AG1 in the first process PR1.

The graph G1 shows the sensitivity distributions of the R pixels, G pixels, B pixels and IR pixels prior to gain adjustment, and the graph G2 shows the sensitivity distributions of the R pixels, G pixels, B pixels and IR pixels after gain adjustment. In the graph G1 and the graph G2, the horizontal axes are the wavelengths WL (nm) of light, and the vertical axes are the light sensitivity LS (%).

In the graphs G1, the graph G11 shows the sensitivity distribution of the B pixels prior to gain adjustment, the graph G12 shows the sensitivity distribution of the G pixels prior to gain adjustment, the graph G13 shows the sensitivity distribution of the R pixels prior to gain adjustment, and the graph G14 shows the sensitivity distribution of the IR pixels prior to gain adjustment.

The sensitivity LS1 is the sensitivity of the IR light component in the sensitivity distribution of the IR pixels prior to gain adjustment shown in the graph G14.

The sensitivity S13 is the sensitivity of the R light component in the sensitivity distribution of the R pixels prior to gain adjustment as shown in the graph G13. The sensitivity S12 is the sensitivity of the G light component in the sensitivity distribution of the G pixels prior to gain adjustment shown in the graph G12. The sensitivity S11 is the sensitivity of the B light component in the sensitivity distribution of the B pixels prior to gain adjustment as shown in the graph G11.

In the graphs G2, the graph G21 shows the sensitivity distribution of the B pixels after gain adjustment, the graph G22 shows the sensitivity distribution of the G pixels after gain adjustment, the graph G23 shows the sensitivity distribution of the R pixels after gain adjustment, and the graph G24 shows the sensitivity distribution of the IR pixels after gain adjustment.

The gain adjusting unit 114 adjusts the gain GR1 of the output signals for the R pixels so that the sensitivity S13 of the R light components included in the output signals of the R pixels will match the sensitivity LS1 of the IR light components included in the output signals of the IR pixels. That is, the gain adjusting unit 114 calculates the gain GR1 through the following equation (1):

GR1=LS1/S13 (1)

Additionally, the gain adjusting unit 114 adjusts the gain GG1 for the output signals of the G pixels so that the sensitivity S12 of the G light components that are included in the outputs of the G pixels will match the sensitivity LS1 of the IR light components that are included in the output signals of the IR pixels. That is, the gain adjusting unit 114 calculates the gain GG1 through the following equation (2):

GG1=LS1/S12 (2)

Additionally, the gain adjusting unit 114 adjusts the gain GB1 for the output signals of the B pixels so that the sensitivity S11 of the B light components that are included in the outputs of the B pixels will match the sensitivity LS1 of the IR light components that are included in the output signals of the IR pixels. That is, the gain adjusting unit 114 calculates the gain GB1 through the following equation (3):

GB1=LS1/S11 (3)

In this way, by adjusting the gain GR1, the gain GG1 and the gain GB1, the sensitivity for the R light components included in the output signals of the R pixels, the sensitivity of the G light components included in the output signals of the G pixels, and the sensitivities of the B light components included in the output signals of the B pixels becomes to match the sensitivities of the IR light components included in the output signals of the IR pixels.

This enables the white balance of the visible light image PA21 prior to gain adjustment to be adjusted appropriately. That is, this enables the generation of the first visible light image PA3 wherein the white balance has been adjusted appropriately.

[4. Second Process]

Next, the second process PR2 will be explained in reference to FIG. 4 and FIG. 5.

FIG. 4 is a diagram explaining an example of the second process PR2 for outputting the second infrared light image PB6.

The image PB11 is an “RGB-IR layout” image that is generated by the imaging unit 21 in the first state ST1. The image PB12 is an “RGB-IR layout” image that is generated by the imaging unit 21 in the second state ST2.

The explanation of the “RGB-IR layout” is omitted here because it is the same way as for image PA1 explained in reference to FIG. 2.

In the first state ST1, the imaging unit 21 outputs the output signal SB21 and the output signal SB31 to the signal processing unit 23. The output signal SB21 corresponds to a visible light image PB21. The output signal SB31 corresponds to an infrared light image PB31.

The signal processing unit 23 generates the visible light image PB21 from the output signal SB21, and generates the infrared light image PB31 from the output signal SB31.

In the second state ST2, the imaging unit 21 outputs the output signal SB22 and the output signal SB32 to the signal processing unit 23. The output signal SB22 corresponds to a visible light image PB22. The output signal SB32 corresponds to an infrared light image PB32.

The signal processing unit 23 generates the visible light image PB22 from the output signal SB22, and generates the infrared light image PB32 from the output signal SB32.

The visible light images PB21 and PB22 are images in the “RGGB layout.”

The explanation of the structure of the “RGGB layout” is omitted here because it is the same as for visible light image PA21 explained in reference to FIG. 2.

The explanation of the infrared light image PB31 and infrared light image PB32 is omitted here because they are similar to the first infrared light image PA22 explained in reference to FIG. 2.

The second processing unit 112 causes the gain adjusting unit 114 to execute a second gain adjusting process AG2, to adjust a gain GR2, a gain GG2, and a gain GB2.

The gain adjusting unit 114 multiplies, by the gain GR2, the output signals from each of the R pixels included in the visible light images PB21 and s PB22. The gain adjusting unit 114 also multiplies, by the gain GG2, the output signals from each of the G pixels included in the visible light images PB21 and PB22. The gain adjusting unit 114 also multiplies, by the gain GB2, the output signals from each of the B pixels included in the visible light images PB21 and PB22.

Moreover, the second processing unit 112 executes a first layout changing process PR21 as a part of the second process. The first layout changing process PR21 is a process that changes the visible light image PB21 and visible light image PB22 of the “RGGB layout” into an “RGB-IR layout.” As a result, the second processing unit 112 generates visible light images PB41 and PB42. The visible light image PB41 corresponds to the visible light image PB21. The visible light image PB42 corresponds to the visible light image PB22.

Both the visible light image PB21 and the visible light image PB22 are composed by R pixels, G pixels and B pixels, as illustrated in FIG. 4, thus the output signals from the IR pixels are missing in both the visible light images PB41 and PB42 of the “RGB-IR layout.” In the visible light images PB41 and PB42 of FIG. 4, the missing output signals for the IR pixels are shown as white voids at the positions at which the IR pixels are arranged.

The second processing unit 112 executes a difference value calculating process PR22 as a part of the second process. In other words, the second processing unit 112 makes the image generating unit 115 to execute the difference value calculating process PR22. The difference value calculating process PR22 is a process for calculating the difference values between the outputs of each of the output signals for the R pixels, the G pixels and the B pixels in the first state ST1 and the output signals from each of the R pixels, G pixels and B pixels in the second state ST2.

As the difference value calculating process PR22, the second processing unit 112 may calculate, for example, difference values ΔR between the output signals of the R pixels composing the visible light image PB41 and the output signals of the R pixels composing the visible light image PB42.

Also, as the difference value calculating process PR22, the second processing unit 112 may calculate, for example, difference values ΔG between the output signals of the G pixels composing the visible light image PB41 and the output signals of the G pixels composing the visible light image PB42.

Also, as the difference value calculating process PR22, the second processing unit 112 may calculate, for example, difference values ΔB between the output signals of the B pixels composing the visible light image PB41 and the output signals of the B pixels composing the visible light image PB42.

Because in the first state ST1 the infrared light emitting unit 25 emits infrared light, R light components and IR light components are included in the output signals of the R pixels composing the visible light image PB41, for example. In the second state ST2, the infrared light emitting unit 25 does not emit infrared light, and thus the output signals of the R pixels composing the visible light image PB42 are composed by the R light components alone.

The magnitudes of the R light components in the output signals of the R pixels composing the visible light image PB41 are identical to the magnitudes of the R light components of the output signals of the R pixels composing the visible light image PB42.

Consequently, the magnitudes of the difference values ΔR will be identical to the magnitudes of the IR light components of the light that is incident into the R pixels in the first state ST1. Similarly, the magnitudes of the difference values ΔG will be identical to the magnitudes of the IR light components of the light that is incident into the G pixels in the first state ST1, and the magnitudes of the difference values ΔB will be identical to the magnitudes of the IR light components of the light that is incident into the B pixels in the first state ST1.

The IR light components in the positions corresponding to each of the R pixels, G pixels, and B pixels in the visible light image PB41 are produced thereby. The IR light components structure a unit of the second infrared light image PB6.

Moreover, the second processing unit 112 executes a second layout changing process PR23 as a part of the second process. In other words, the second processing unit 112 makes the image generating unit 115 to execute a second layout change process PR23. The second layout change process PR23 is a process for arranging the respective output signals for the IR pixels composing the infrared light image PB31 at the positions of the visible light image PB41 of the “RGB-IR layout” wherein the IR pixel information is missing. In other words, the second layout changing process PR23 is a process that arranges the respective output signals of the IR pixels composing the infrared light image PB31 in the positions of the IR pixels in the visible light images PB41 and PB42 of the “RGB-IR layout” generated by the imaging unit 21. As a result, an infrared light image PB51 is generated.

The second processing unit 112 also executes a combining process PR24 as a part of the second process. In other words, the second processing unit 112 makes the image generating unit 115 to execute the combining process PR24. The combining process PR24 is a process for generating a second infrared light image PB6 from the difference values ΔR, ΔG and ΔB, and the infrared light image PB51.

In the combining process PR24, the second processing unit 112 generates the second infrared light image PB6, by combining the infrared light image PB51 and the IR light components at the positions corresponding to each of the R pixels, G pixels and B pixels in the visible light image PB41 obtained through the difference value calculating process PR22.

The second gain adjusting process AG2 executed by the gain adjusting unit 114 will be explained by referring FIG. 5. FIG. 5 is graphs showing an example of the second gain adjusting process AG2 in the second process PR2.

The graph G1 shows the sensitivity distributions of the R pixels, G pixels, B pixels, and IR pixels prior to gain adjustment, and the graph G3 shows the sensitivity distributions of the R pixels, G pixels, B pixels, and IR pixels after gain adjustment. In the graph G1 and the graph G3, the horizontal axes are the wavelengths WL (nm) of light, and the vertical axes are the light sensitivity LS (%).

Note that the graph G1 is identical to the graph G1 shown in FIG. 3. The sensitivity LS2 is the sensitivity of the IR light components in the sensitivity distribution for the IR pixels prior to gain adjustment, shown in the graph G14. The sensitivity LS2 matches the sensitivity LS1 shown in FIG. 3.

The sensitivity S23 is the sensitivity of the IR light component in the sensitivity distribution of the R pixels prior to gain adjustment, as shown in the graph G13. The sensitivity S22 is the sensitivity of the IR light component in the sensitivity distribution of the G pixels prior to gain adjustment, shown in the graph G12. The sensitivity S21 is the sensitivity of the IR light component in the sensitivity distribution of the B pixels prior to gain adjustment, as shown in the graph G11.

In the graphs G3, the graph G31 shows the sensitivity distribution of the B pixels after gain adjustment, the graph G32 shows the sensitivity distribution of the G pixels after gain adjustment, the graph G33 shows the sensitivity distribution of the R pixels after gain adjustment, and the graph G34 shows the sensitivity distribution of the IR pixels after gain adjustment.

The gain adjusting unit 114 adjusts the gain GR2 of the output signals for the R pixels so that the sensitivity S23 of the IR light components included in the output signals of the R pixels will match the sensitivity LS2 of the IR light components included in the output signals of the IR pixels. That is, the gain adjusting unit 114 calculates the gain GR2 through the following equation (4):

GR2=LS2/S23 (4)

Additionally, the gain adjusting unit 114 adjusts the gain GG2 for the output signals of the G pixels so that the sensitivity S22 of the IR light components that are included in the outputs of the G pixels will match the sensitivity LS1 of the IR light components that are included in the output signals of the IR pixels. That is, the gain adjusting unit 114 calculates the gain GG2 through the following equation (5):

GG2=LS2/S22 (5)

Additionally, the gain adjusting unit 114 adjusts the gain GB2 for the output signals of the B pixels so that the sensitivity S21 of the IR light components that are included in the outputs of the B pixels will match the sensitivity LS2 of the IR light components that are included in the output signals of the IR pixels. That is, the gain adjusting unit 114 calculates the gain GB2 through the following equation (6):

GB2=LS2/S21 (6)

In this way, by adjusting the gain GR2, the gain GG2 and the gain GB2 the sensitivity for the IR light components included in the output signals of the R pixels, the sensitivity of the IR light components included in the output signals of the G pixels, and the sensitivities of the IR light components included in the output signals of the B pixels becomes to match the sensitivities of the IR light components included in the output signals of the IR pixels. Consequently, the sensitivities of the R pixels, G pixels and B pixels composing the second infrared light image PB6 can be adjusted appropriately. That is, the image, wherein the sensitivities of the R pixels, G pixels, B pixels and IR pixels have been adjusted appropriately, can be generated as the second infrared light image PB6.

[5. Processes in the Control Unit]

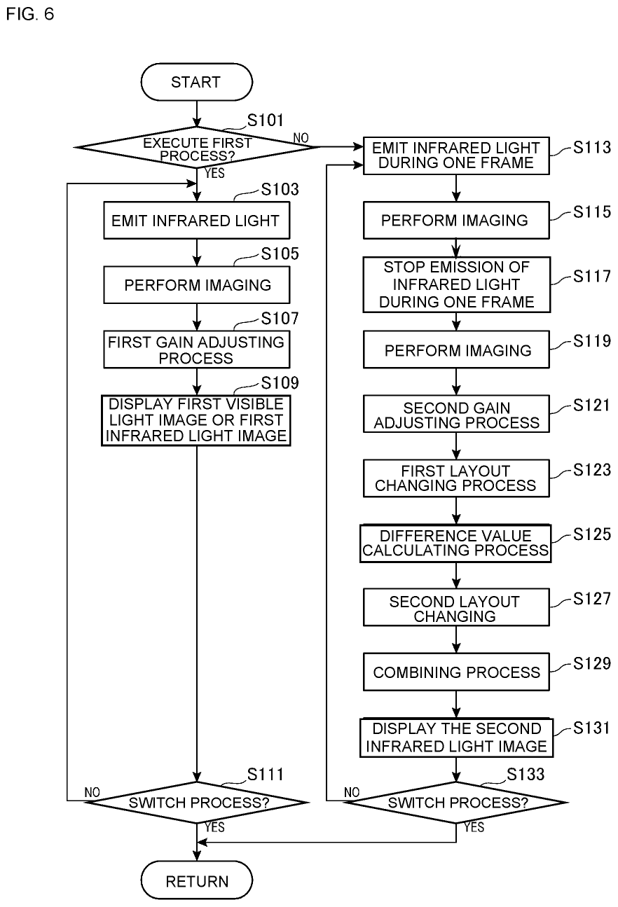

The processes in the control unit 1 will be explained by referring FIG. 6. FIG. 6 is a flowchart showing an example of the processes in the control unit 1.

First, in Step S101, the switching unit 113 evaluates, in response to an instruction from a user, for example, whether or not to execute the first process PR1. In other words, the switching unit 113 selects whether to execute the first process PR1 or the second process PR2.

If the switching unit 113 has evaluated that the first process PR1 will not be executed, that is, that the second process PR2 is to be executed (Step S101: NO), processing advances to Step S113. If the switching unit 113 evaluates that the first process PR1 is to be executed (Step S101: YES), processing advances to Step S103.

Given this, in Step S103, the first processing unit 111 makes the infrared light emitting unit 25 to emit infrared light.

Following this, in Step S105, the first processing unit 111 makes the imaging unit 21 to generate the output signal SA1, and outputs the output signals SA21 and SA22 to the signal processing unit 23. The signal processing unit 23 generates a visible light image PA21 from the output signal SA21, and also generates a first infrared light image PA22 from the output signal SA22.

Next, in Step S107, the gain adjusting unit 114 executes the first gain adjusting process AG1. The first gain adjusting process AG1 is the process for adjusting the gains GR1, GG1 and GB1. Each of the gains GR1, sGG1 and GB1 is multiplied with the respective output signals of the R pixels, G pixels, and B pixels. As a result, the first visible light image PA3 is generated.

Next, in Step S109, the display control unit 116 displays the first visible light image PA3 or the first infrared light image PA22 on the display 27.

Next, in Step S111, the switching unit 113 evaluates whether or not to switch from the first process PR1 to the second process PR2 by following an instruction from the user.

If the evaluation by the switching unit 113 is not to switch from the first process PR1 to the second process PR2 (Step S111: NO), processing returns to Step S103. If the evaluation by the switching unit 113 is to switch from the first process PR1 to the second process PR2 (Step S111: YES), processing returns to Step S101.

When Step S101 is NO, that is, where the switching unit 113 evaluates that the second process PR2 is to be executed, then, in Step S113, the second processing unit 112 causes the infrared light emitting unit 25 to emit infrared light during one frame.

Next, in Step S115, the second processing unit 112 makes the imaging unit 21 to generate the output signal SB21 and the output signal SB31, and to output the output signal SB21 and the output signal SB31 to the signal processing unit 23. The signal processing unit 23 generates the visible light image PB21 from the output signal SB21, and generates the infrared light image PB31 from the output signal SB31.

Next, in Step S117, the second processing unit 112 makes the infrared light emitting unit 25 to stop emitting infrared light during one frame.

Next, in Step S119, the second processing unit 112 makes the imaging unit 21 to generate the output signal SB22 and the output signal SB32, and to output the output signal SB22 and the output signal SB32 to the signal processing unit 23. The signal processing unit 23 generates the visible light image PB22 from the output signal SB22, and generates the infrared light image PB32 from the output signal SB32.

Following this, in Step S121, the gain adjusting unit 114 executes the second gain adjusting process AG2. The second gain adjusting process AG2 is a process for adjusting the gains GR2, GG2 and GB2. Each of the gains GR2, GG2 and GB2 is multiplied with the respective output signals from the R pixels, G pixels, and B pixels.

Next, in Step S123, the second processing unit 112 executes the first layout change process PR21. The first layout change process PR21 is a process for changing the visible light images PB21 PB22, of the “RGGB layout” to the “RGB-IR layout.” As a result, the visible light images PB41 and PB42 are generated.

Following this, in Step S125, the second processing unit 112 executes the difference value calculating process PR22. The difference value calculating process PR22 is a process for calculating the difference values between each of the output signals of the R pixels, the G pixels, and the B pixels in the first state ST1 and the output signals for each of the R pixels, G pixels, and B pixels in the second state ST2. The difference values constitute the difference values ΔR, the difference values ΔG, and the difference values ΔB.

Next, in Step S127, the second processing unit 112 executes the second layout change process PR23. The second layout change process PR23 is a process that arranges each of the output signals of the IR pixels composing the infrared light image PB31 into the positions of the IR pixels in the visible light image PB41 having the “RGB-IR layout,” which is generated by the imaging unit 21, for example. The infrared light image PB51 is generated thereby.

Next, in Step S129, the image generating unit 115 executes the combining process PR24. The combining process PR24 is a process for generating the second infrared light image PB6 from the difference values ΔR, ΔG and ΔB, and the infrared light image PB51.

Next, in Step S131, the display control unit 116 displays the second infrared light image PB6 on the display 27.

Next, in Step S133, the switching unit 113 evaluates whether or not to switch from the second process PR2 to the first process PR1 in accordance with an instruction from the user.

If the switching unit 113 evaluates that the second process PR2 is not to be switched to the first process PR1 (Step S133: NO), processing returns to Step S113. If the switching unit 113 evaluates that the second process PR2 is to be switched to the first process PR1 (Step S133: YES), processing returns to Step S101.

Step S101 corresponds to an example of a “switching step.”

As explained in reference to FIG. 6, the switching unit 113 switches between the first process PR1 and the second process PR2 in accordance with an instruction from the user. Thus, the user is able to select whether to display the first visible light image PA3 or the first infrared light image PA22 on the display 27, or to display the second infrared light image PB6 on the display 27. This enables an improvement in convenience for the user.

[6. Structure of the Imaging Device, and Effects Thereof]

The imaging device 100 according to the present embodiment comprises: an imaging unit 21 wherein R pixels, G pixels, B pixels and IR pixels are arranged periodically; an infrared light emitting unit 25 that emits infrared light to the surroundings; a signal processing unit 23 that generates an image from an output signal of the imaging unit 21; and a control unit that controls the imaging unit 21, the infrared light emitting unit 25 and the signal processing unit 23, wherein each of the R pixels, the G pixels, the B pixels and the IR pixels has a filter that is transparent to IR light, and the control unit 1 switches its control by a switching unit 113 between a first process PR1 wherein the signal processing unit simultaneously generate a visible light image PA21 from the output signals of the R pixels, the G pixels and the B pixel of the imaging unit, and a first infrared light image PA22 from the output signals of the IR pixels of the imaging unit 21, and a second process PR2 wherein the imaging unit 21 outputs the output signals during a first state ST1 during which the infrared light emitting unit 25 is emitting infrared light and in a second state ST2 during which the infrared light emitting unit 25 is not emitting infrared light, and the signal processing unit 23 generates a second infrared light image PB6 from difference values ΔR, ΔG and ΔB between the output signals of the R pixels, the G pixels and the B pixels during the first state ST1 and the output signals of the R pixels, the G pixels and the B pixels during the second state ST2, and the output signals of the IR pixels in the first state ST1.

Through this structure, the visible light image PA21 and first infrared light image PA22 are generated when the control unit 1 executes the first process PR1, and the second infrared light image PB6 is generated when the control unit 1 executes the second process PR2. The second infrared light image PB6 has higher resolution compared with the resolution of the first light infrared image PA22. Also, the switching unit 113 switches between the first process PR1 and the second process PR2.

Consequently, the image generated by the control unit 1 can be switched between the combination of the visible light image PA21 and the low-resolution first infrared light image PA22, and the high-resolution second infrared light image PB6 alone.

In the imaging device 100, the control unit 1 comprises the gain adjusting unit 114 for adjusting the gains GR2, GG2 and GB2 of the output signals of the R pixels, G pixels, and B pixels.

Through this structure, in the second process PR2, the gain adjusting unit 114 adjusts these gains so that the sensitivities S21-S23 of the infrared light components included in the output signals of the R pixels, G pixels, and B pixels in the first state ST1 will match the sensitivities LS2 of the output signals of the IR pixels in the first state ST1.

The sensitivities of the R pixels, G pixels, and B pixels composing the second infrared light image PB6 can be adjusted appropriately. That is, the image wherein the sensitivities of the R pixels, G pixels, B pixels and IR pixels have been adjusted appropriately can be generated as the second infrared light image PB6.

Additionally, in the imaging unit 21 of the imaging device 100, the R pixels, the G pixels, the B pixels, and the IR pixels are arranged in an RGB-IR layout. The visible light image included in the output signals from the imaging unit 21, is in an RGGB layout. The control unit 1 provides the image generating unit 115 that generates the second infrared light image PB6 by arranging the difference values ΔR, ΔG and ΔB, and the output signals of the IR pixels in the first state ST1 into RGB-IR layout in the second process PR2.

Through this structure, the image generating unit 115 generates the second infrared light image PB6 by arranging the difference values ΔR, ΔG, ΔB, and the output signals of the IR pixels in the first state ST1 into an RGB-IR layout. The difference values ΔR correspond to the IR light components of the light received by the R pixels in the first state ST1, the difference values ΔG correspond to the IR light components of the light received by the G pixels in the first state ST1, and the difference values ΔB correspond to the IR light components of the light received by the B pixels in the first state ST1.

Consequently, A high-resolution infrared light image can be generated as the second infrared light image PB6 because the second infrared light image PB6 is generated by arranging the IR light components of the light received by the R pixels, the G pixels and the B pixels, and the output signals of the IR pixels into the RGB-IR layout.

The imaging device method according to the present embodiment is an imaging method in an imaging device 100. The imaging device 100 comprises an imaging unit 21 wherein R pixels, G pixels, B pixels and IR pixels are arranged periodically; an infrared light emitting unit 25 that emits infrared light to the surroundings; a signal processing unit 23 that generates an image from an output signal of the imaging unit 21; and a control unit 1 that controls the imaging unit 21, the infrared light emitting unit 25 and the signal processing unit 23, each of the R pixels, the G pixels, the B pixels and the IR pixels has a filter that is transparent to IR light. The imaging method is executed by the control unit 1 by switching the steps of: a first step PR1 wherein the signal processing unit 23 simultaneously generate a visible light image PA21 from the output signals of the R pixels, the G pixels and the B pixel of the imaging unit 21, and a first infrared light image PA22 from the output signals of the IR pixels of the imaging unit 21; and a second step PR2 wherein the imaging unit 21 outputs the output signals during a first state ST1 during which the infrared light emitting unit 25 is emitting infrared light and in a second state ST2 during which the infrared light emitting unit 25 is not emitting infrared light, and the signal processing unit 23 generates a second infrared light image PB6 from difference values ΔR, ΔG and ΔB between the output signals of the R pixels, the G pixels and the B pixels during the first state ST1 and the output signals of the R pixels, the G pixels and the B pixels during the second state ST2, and the output signals of the IR pixels in the first state ST1.

This method has the same effects in operation as the imaging device 100 according to the present embodiment.

[7. Other Embodiments]

The embodiment explained above is no more than an example of one aspect of the present invention, and the present invention may be modified and applied appropriately in a range that does not deviate from the spirit and intent thereof.

While in the present embodiment is explained for a case that the control unit 1 is an ECU, embodiments of the present invention are not limited thereto. The control unit 1 only should comprise a processor and a memory. For example, the control unit 1 may be an FPGA, an SoC, or the like.

While the explanation for the present embodiment was for a case wherein the visible light image and infrared light image that were generated by the control unit 1 are displayed on a display 27, there is no limitation thereto. The visible light image and infrared light image that are generated by the control unit 1 may instead be used in the various types of control of vehicles. In this case, the control unit 1 would transmit the vehicle light image and infrared light image through an onboard network such as a CAN (Controller Area Network) to an ECU that carries out various types of control of the vehicle.

While in the embodiment set forth above the explanation was for a case wherein the switching unit 113 switched between the first process PR1 and the second process PR2 in response to an instruction from a user, there is no limitation thereto. For example, the brightness within the cabin of a vehicle wherein the imaging device 100 is mounted may be detected by a brightness sensor, and the switching unit 113 may switch between the first process PR1 and the second process PR2 depending on the detected brightness. For example, if the detected brightness is greater than a prescribed brightness level, the switching unit 113 may select the first process PR1, and if the detected brightness is dimmer than the prescribed brightness, the switching unit 113 may select the second process PR2.

For ease in understanding the application of the present invention, FIG. 1 is a schematic diagram illustrated partitioned according to the main processing content of the control unit 1 of the imaging device 100; however the individual structures of the control unit 1 of the imaging device 100 may be partitioned into more structural elements depending on the processing detail. Moreover, the partitioning may be such that more processes are carried out by a single structural element. Moreover, the processes in any of the structural elements may be executed in a single hardware or executed by a plurality of hardware. Moreover, the processes of each structural elements may be achieved by a single program, or by a plurality of programs.

For ease in understanding the processes in the control unit 1, the processing units in the flowchart presented in FIG. 6 are partitioned depending on the main processes. The invention according to the present application is not limited by the names of the processing units or the methods by which they are partitioned. The processes of the control unit 1 may be divided into more processing units depending on the process details. Moreover, a single processing unit may be further partitioned so as to include multiple processes. Furthermore, the processing sequence in the flowchart is also not limited to the example that is illustrated.

Furthermore, the imaging process may be achieved through causing a control program 121 in accordance with the imaging method to run on a processor 11 provided by the control unit 1. Additionally, a control program 121 may be recorded on a recording medium that is recorded so as to be readable by a computer.

The recording medium may use a magnetic or optical recording medium, or a semiconductor memory device. Specifically, it may be a fixed recording medium or a portable recording medium such as a flexible disk, an HDD, a CD-ROM (Compact Disk Read-Only Memory), a DVD, a Blu-ray® disc, a magnetooptical disc, a flash memory, a card-type recording medium, or the like. Moreover, the recording medium may be a RAM, a ROM, or a non-volatile storage device, such as an HDD, that is a storing device provided within the control unit 1.

The imaging method may be achieved by storing the control program 121 in a server device, or the like, and downloading the control program 121 from the server device into the control unit 1.

### EXPLANATIONS OF REFERENCE SYMBOLS

100: Imaging Device
1: Control Unit
11: Processor
111: First Processing Unit
112: Second Processing Unit
113: Switching Unit
114: Gain Adjusting Unit
115: Image Generating Unit
116: Display Control Unit
12: Memory
121: Control Program
122: Gain Storing Unit
21: Imaging Unit
23: Signal Processing Unit
25: Infrared Light Emitting Unit
27: Display
PA21: Visible Light Image
PA3: First Infrared Light Image
PB6: Second Infrared Light Image
ST1: First State
ST2: Second State
ΔR, ΔG, ΔG: Difference Values

What is claimed is:

1. An imaging device, comprising:
an imaging unit wherein R pixels, G pixels, B pixels and IR pixels are arranged periodically;
an infrared light emitting unit that emits infrared light to the surroundings;
a signal processing unit that generates an image from an output signal of the imaging unit; and
a control unit that controls the imaging unit, the infrared light emitting unit and the signal processing unit,
wherein each of the R pixels, the G pixels, the B pixels and the IR pixels has a filter that is transparent to IR light, and the control unit switches its control between:
a first process wherein the signal processing unit simultaneously generate a visible light image from the output signals of the R pixels, the G pixels and the B pixel of the imaging unit, and a first infrared light image from the output signals of the IR pixels of the imaging unit; and
a second process wherein the imaging unit outputs the output signals during a first state during which the infrared light emitting unit is emitting infrared light and in a second state during which the infrared light emitting unit is not emitting infrared light, and the signal processing unit generates a second infrared light image from difference values between the output signals of the R pixels, the G pixels and the B pixels during the first state and the output signals of the R pixels, the G pixels and the B pixels during the second state, and the output signals of the IR pixels in the first state.

2. The imaging device according to claim 1, wherein the control unit comprises a gain adjusting unit that adjusts the gains of the output signals from the R pixels, the G pixels, and the B pixels so that the sensitivities to the infrared light components included in the output signals of the R pixels, the G pixels and the B pixels will match the sensitivities of the output signals of the IR pixels during the first state of the second process.

3. The imaging device according to claim 2, wherein
the R pixels, the G pixels, the B pixels and the IR pixels are arranged in an RGB-IR layout in the imaging unit,
the output signals for the visible light image is outputted in an RGGB layout from the imaging unit; and
the control unit comprises an image generating unit that generates the second infrared light image in the second process by arranging the difference values and the output signals of the IR pixels in the first state into an RGB-IR layout.

4. The imaging device according to claim 1, wherein
the R pixels, the G pixels, the B pixels and the IR pixels are arranged in an RGB-IR layout in the imaging unit,
the output signals for the visible light image is outputted in an RGGB layout from the imaging unit; and
the control unit comprises an image generating unit that generates the second infrared light image in the second process by arranging the difference values and the output signals of the IR pixels in the first state into an RGB-IR layout.

5. An imaging method of an imaging device:
wherein the imaging device comprises an imaging unit wherein R pixels, G pixels, B pixels and IR pixels are arranged periodically; an infrared light emitting unit that emits infrared light to the surroundings; a signal processing unit that generates an image from an output signal of the imaging unit; and a control unit that controls the imaging unit, the infrared light emitting unit, and the signal processing unit, each of the R pixels, the G pixels, the B pixels and the IR pixels has a filter that is transparent to IR light;
the imaging method is executed by the control unit by switching the steps of:
a first step wherein the signal processing unit simultaneously generate a visible light image from the output signals of the R pixels, the G pixels and the B pixel of the imaging unit, and a first infrared light image from the output signals of the IR pixels of the imaging unit; and
a second step wherein the imaging unit outputs the output signals during a first state during which the infrared light emitting unit is emitting infrared light and in a second state during which the infrared light emitting unit is not emitting infrared light, and the signal processing unit generates a second infrared light image from difference values between the output signals of the R pixels, the G pixels and the B pixels during the first state and the output signals of the R pixels, the G pixels and the B pixels during the second state, and the output signals of the IR pixels in the first state.
